(19) United States
(12) Patent Application Publication
(10) Pub. No.: US 2007/0052126 A1
(43) Pub. Date: Mar. 8, 2007

(54) Manufacturing Method For Friction Material Products

(75) Inventors: Masanori Chiba, Gunma-ken (JP); Yasuji Ishii, Gunma-ken (JP)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: NISSHINBO INDUSTRIES, INC., Tokyo (JP)

(21) Appl. No.: 11/530,382

(22) Filed: Sep. 8, 2006

(30) Foreign Application Priority Data
Sep. 8, 2005 (JP) JP2005-260079

(51) Int. Cl. B27N 3/00

(52) U.S. Cl. 264/109; 264/122

(57) ABSTRACT

To provide the manufacturing method for the friction material products which does not require the special molding die and realizes the significant simplification of the molding step while maintaining the quality of the friction material. The manufacturing method for the friction material products comprising the molding step of pressurizing and heating to mold the molding material made of the raw friction material within the molding die, wherein the molding temperature in the molding step is 190° C.-230° C. and the pressure thereof is 100 MPa-200 MPa.

### FIELD OF THE INVENTION

This invention relates to friction material products preferably used for such as a disc pad and a brake lining for such as an automobile and a heavy duty truck.

### BACKGROUND OF THE INVENTION

Among various friction material products, there are products such as the disc pad comprised of the friction material fixed on a back plate and the brake lining which is the friction material as itself. Generally, the friction material products are produced through a “mixing step” where the raw friction material made of such as a fiber base material, filler, and resin (binder) are evenly mixed with a mixer such as Redige mixer and Eirich mixer, a “preliminarily forming step” where a preliminarily formed product is made as filling the respective mixed materials of fixed quantity in a metal die and is pressurized by a pressing device, a “molding step” where the preliminarily formed product is pressurized and heated by another pressing device, (wherein for the disc pad, the friction material is fixed to the back plate which goes through certain steps such as punching, degreasing process, blasting process, chemical conversion treatment, and primer coating process prior to this molding step), a “heat treatment step” where a reaction of the thermosetting resin of the entire friction material product is completed to secure stability and mechanical strength of the friction resin, a “painting step”, a “grinding step” where a surface of the friction material is ground, slit, and chamfers are formed, a “heat shearing step” where braking effect of a new friction material is secured as lightly burning the surface of the friction material, and an “inspection step”.

An example of a metal die to be used in the molding step is shown in FIG. 1. There are an upper die 1, a middle die 2 with a vertical penetrating hole, and a lower die 3 inserted in the penetrating hole of the middle die 2, and the upper die 1, the middle die 2, and the lower die 3 constitute the embodiment of the heat press device in this invention. The friction material 4 is molded by the heat press device, and the friction material 4 is fixed to a back plate 5. FIG. 1 illustrates an example of manufacturing a disc pad in which the friction material 4 is fixed to the back plate 5; however, this invention is applicable to a case when the friction material 4 itself is a product without being fixed to the back plate such as the brake lining.

As disclosed in the Japanese Provisional Patent Publication No. 2003-268352, generally, the molding step is done by pressurizing and heating under the pressure of 30 MPa-50 MPa at die temperature of 130° C.-230° C. for 5 minutes-15 minutes. Additionally, as disclosed in the Japanese Provisional Patent Publication No. 2003-145565, the raw friction material contains the thermosetting resin as the binder so as to depressurize, i.e., outgassing, numerous times during the pressurizing and heating step. Under these conditions, although the friction material is indispensable for a quality control purpose, shortening the processing period of molding step is desirable in consideration of reducing the cost of the friction material. To respond to the above problem, the Japanese Provisional patent Publication No. 2003-145565 discloses a method of exhausting the generated gas to outside of the molding die through an outgas channel, which is opened on a middle die inner surface, from a position contacting a final curing portion of a preliminarily formed product, allowing the reduction of processing time. However, this method requires a special metal die, which increases the cost thereof. Japanese Provisional Patent Publication No. 2003-145568 is another reference of the background of this invention.

### SUMMARY OF THE INVENTION

This invention was made in consideration of the above-circumstances and is to provide a manufacturing method for friction material products, which realizes a significant reduction of molding step without using the special molding die.

In order to attain the above-object, inventors of this invention initially focused on the die temperature and tried to increase the die temperature of the current molding die so as to shorten the reaction time of the thermosetting resin. However, a simple step of increasing the die temperature did not allow the resin to reach to the entire fricton material, which left some portions with small binding force among the raw friction materials, or rapidly generated a large volume of gas within the friction material, where depressurizing as outgassing releases the raw friction material in a direction of its thickness, thereby causing the spring back effect. Accordingly, it was found that cracks have been generated in a worst scenario. Therefore, in addition to the increase of the die temperature, a molding pressure was increased to a great extent comparing to the conventional step. Then, it was found that no spring back effect occurred even if the molding time was greatly shortened from the conventional molding time of 5 minutes-15 minutes to 2 minutes or less when the die temperature was set to be 190° C. or higher and the molding pressure was set to be 100 MPa or higher. This phenomenon is considered do to a resin flow within the raw friction material. That is, in comparison to the resin flow under the conventional combination of the die temperature and pressure, the resin flow under the condition of the greatly increased die temperature and the molding pressure becomes much larger (faster). In the case that the resin flow is large (fast), it is estimated that the resin tends to smoothly reach though gaps among the raw friction materials (such as fiber base material and filler), which eliminates the portion with small binding force among the raw friction materials in the short period of time, and that the resin reaches to the entire friction material as pushing the gas outside the friction material, which eliminates a possibility of leaving the gas within the friction material.

That is, the present invention provides the following manufacturing method for the friction material products:
(1) the manufacturing method for the friction material product comprising the molding step of pressurizing and heating to mold the molding material made of the raw friction material within the molding die, wherein the molding temperature in the molding step is 190° C.-230° C. and the pressure thereof is 100 MP-200 MPa,
(2) the manufacturing method for the friction material product comprising the molding step of pressurizing and heating to mold the molding material made of the raw friction material within the molding die with the upper die, the middle die, and the lower die, wherein the molding temperature of the upper die and the lower die in the molding step is 190° C.-230° C. and the pressure thereof is 100 MP-200 MPa;
(3) the manufacturing method for the friction material product according to (2), wherein the middle die is made of the porous material;
(4) the manufacturing method for the friction material product according to (1)-(3), wherein the molding material product is the granulated substance; and
(5) the manufacturing method for the friction material product according to (1)-(4), wherein the molding material is preheated.

The manufacturing method of the present invention provides the manufacturing method for the friction material products which does not require the special molding die and realizes a significant reduction of molding step while maintaining the quality of the friction material.

### BRIEF DESCRIPTION OF THE DRAWINGS

The above and other objects of the present invention will become readily apparent by reference to the following detailed description when considered in conjunction with the accompanying drawings wherein:

FIG, 1 is a figure illustrating an example of a metal die to be used in the molding step is shown in FIG. 1;

FIG. 2 is a chart showing components of the raw friction material to be mixed in Redige mixer;

FIG. 3 is a chart showing the formation condition to manufacture the friction material in the embodiments 1-11; and

FIG. 4 is a chart showing the formation condition to manufacture the friction material in the comparative examples 1-8.

### EMBODIMENTS OF THE INVENTION

The present invention is the manufacturing method for the friction material product comprising the molding step of pressurizing and heating to mold the molding material made of the raw friction material within the molding die, wherein the molding temperature in the molding step is 190° C.-230° C. and the pressure thereof is 100 MPa-200 MPa.

The temperature of the molding die is 190° C.-230° C. and preferably is 200° C.-210 ° C. When the die temperature is tower than the above-ranges, viscosity of the thermosetting resin of the raw friction material is too high, and the resin does not reach to the entire friction material, thereby possibly reducing the strength of the friction material. Contrary to the above-situation, when the die temperature is higher than the above-range, cure rate of the resin becomes too high, and the gas, which is generated from the resin, is sealed in the friction material, thereby possibly causing blistering thereof. The molding pressure is 100 MPa-230 MPa and preferably is 130 MPa-170 MPa. When the molding pressure is lower than the above-ranges, the resin is cured without reaching through the gaps among the raw friction material, which possibly towers the strength of the friction material, and when the molding pressure is higher than the above-ranges, time allowed for outgassing becomes limited, which seals the gas within the friction material and possibly causes the blistering thereof.

When the die is comprised of the upper die, the middle die, and the lower die, it is preferably designed such that the die temperature of the middle die becomes the melting point of the resin contained in the molding material or higher but lower than curing temperature because of the heat conduction of the die temperature of the upper die and the lower die. Metal dies such as alloy tool steel SKD11 (Japanese Industrial Standards G4404;2006) may be used for the middle die 2, but the porous material, for example, thermo conductivity adjusted material such as porous ceramic and thermo conductive controlling filler, may be used to form thereof. These materials allow to control the die temperature of the middle die to be rather lower than that of the upper die and the lower die, i.e., within the resin curing temperature), thereby creating a relief channel for the generated gas. In consideration of the object of this invention, the molding time is ranged between 10 seconds and 300 seconds and more preferably is between 30 seconds and 120 seconds. The quality of the friction material products is maintained with such a short molding time.

Materials which are generally used for the friction material can be used as the raw friction materials. For resin (i.e., binder) materials, such as phenol resin, acrylic rubber denaturation phenol resin, NBR (acrylonitrile butadiene rubber) denaturation phenol resin, benzoxazine resin, melamine resin, epoxy resin, NBR (acrylonitrile butadiene rubber), and acrylic rubber, may be used. These various resins can be used independently or in combination thereof. The fiber base material can be such as metal fiber, for example, steel, stainless, copper, brass, bronze, and aluminum inorganic fiber, for example, potassium titanate fiber ceramic fiber, glass fiber, rock wool, and wollastonite, and organic fiber, for example, aramid fiber, carbon fiber polyimide fiber, cellulose fiber, and acrylic fiber. These various resins can be used independently or in combination thereof. Organic filler and inorganic filler can be used as the filler. For example, cashew dust, vulcanized natural/synthetic rubber powder, tire rubber dust, and acrylic rubber dust may be used for the organic fiber. These various resins can be used independently or in combination thereof. On the other hand, barium sulfate, calcium carbonate, calcium hydroxide, artificial graphite, tin sulfide, mica, coke, alumina, silica, and metal powder such as ion, copper, stainless, and aluminum powder, for example, may be used for the inorganic fiber. These various resins can be used independently or in combination thereof.

The molding material made of the raw friction material used in the present invention is generally preliminarily formed product; however, powder raw friction material mixture without preliminarily forming or granulation substance of the raw friction material mixture can be used. When the granutation substance is used, pressure transfer loss due to the friction among the particles becomes smalt i.e., the resin tends to reach through the raw friction material smoothly, and therefore it is preferable that the preliminarily forming process can be eliminated and also press-heat molding in the short period of time in the molding step is possible.

The molding material can be used without pre-heating but also pre-heated molding material can be used. When pre-heating is performed, generally, external heating such as by using a heat treat furnace is applied; however, internal heating by using high frequency and microwave dielectric heating shorten the time required and is preferable.

After performing the above-described molding step, the friction material moves to the heat treatment steps where the heat treatment can be done in the high temperature atmosphere by a heat treat furnace and placing between high temperature heat plates. The method of placing the object between the heat plates shortens the treatment time and is preferable.

The manufacturing method for the friction material products of this invention is preferable for automotives and is also applicable to a brake of such as a heavy duty truck, a railcar, and various industrial machineries.

### EMBODIMENTS

Embodiments and comparative examples will be shown below for more concrete explanation of the present invention; however, the present invention is not limited to the embodiments described below.

### Embodiments 1-9 and Comparative Examples 1-9

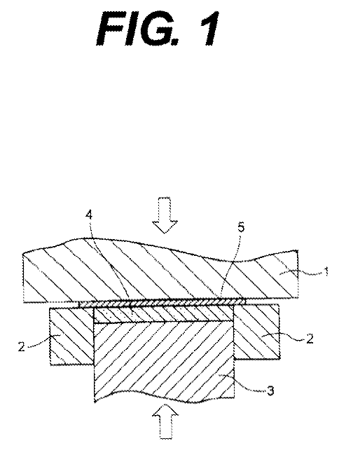

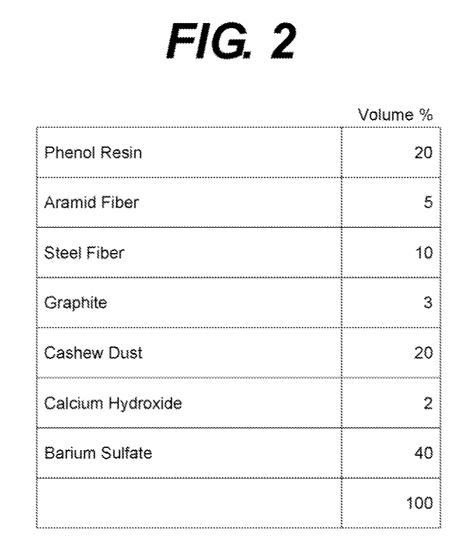

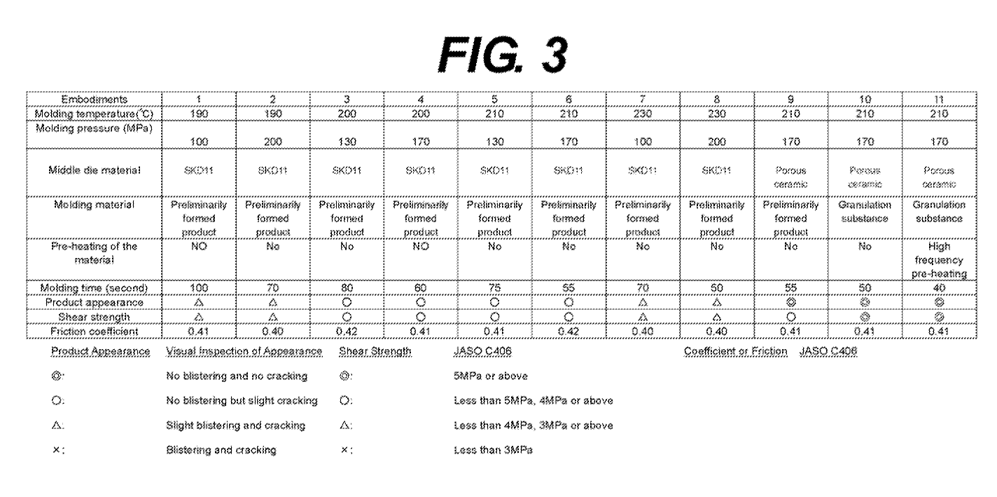

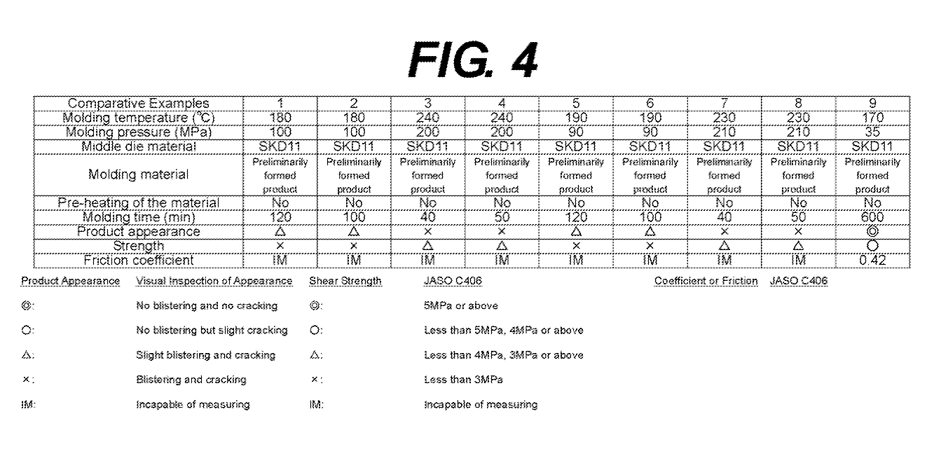

Redige mixer is used to mix the raw friction material, whose components are shown in FIG. 2 for about 5 minutes and is pressurized in the pressuring die under 10 MPa for about 20 seconds for preliminarily forming. Implementing the molding temperature, molding pressure, molding time, middle die material, molding material, and pre-heating of the preliminarily formed product as shown in the conditions of FIGS. 3 and 4, the preliminarily formed product is heated (cured) under 200° C. for about 5 hours to produce the friction material.

Redige mixer is used to mix the raw friction material, whose components are shown in FIG. 2 for about 5 minutes, and 3% weight relative to the entire amount of the raw friction material is added, which is pressurized under 2.4×104 N/cm by a roller compactor (of Turbo Kogyo Co., Ltd.) and is powdered to obtain the granulation substance. Implementing the molding temperature, molding pressure, molding time, middle die material, molding material, and preheating of the granulation substance as shown in the conditions of FIGS. 3 and 4, the preliminarily formed product is heated (cured) under 200° C. for about 5 hours to produce the friction material.

The above-described friction material is evaluated as to a product appearance shear strength, and coefficient of friction. The results are shown in FIGS. 2 and 3.

(1) Product Appearance

Blistering and cracking of the product surface is visually inspected, and the product appearance is evaluated based on the following evaluation standard:
⊚: No blistering and no cracking
◯: No blistering but slight cracking
Δ: Slight blistering and cracking
x: Blistering and cracking
   (2) Shear Strength
JASO C427 Standard
⊚: 5 MPa or above
◯: Less than 5 MPa, 4 MPa or above
Δ: Less than 4 MPa, 3 MPa or above
x: Less than 3 MPa
   (3) Coefficient of Friction
JASO C406 Standard

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Here, there may be obvious modifications to the embodiment described above. Accordingly, reference should be made to the following claims in determining the full scope of the invention.

What we claim is:

1. A manufacturing method for friction material products comprising a molding step of pressurizing and heating to mold a molding material made of a raw friction material within a molding die, wherein a molding temperature in said molding step is 190° C.-230° C. and a pressure thereof is 100 MPa-200 MPa.

2. A manufacturing method for friction material products comprising a molding step of pressurizing and heating to mold a molding material made of a raw friction material within a molding die with an upper die, a middle die, and a lower die, wherein a molding temperature of the upper die and the lower die in said molding step is 190° C.-230° C. and a pressure thereof is 100 MPa-200 MPa.

3. The manufacturing method for friction material products according to claim 2, wherein the middle die is made of a porous material.

4. The manufacturing method for friction material products according to claim 1, wherein the molding material is a granulated substance,

5. The manufacturing method for friction material products according to claim 2, wherein the molding material is a granulated substance.

6. The manufacturing method for friction material products according to claim 3, wherein the molding material is a granulated substance.

7. The manufacturing method for friction material products according to claim 1, wherein the molding material is pre-heated.

8. The manufacturing method for fricton material products according to claim 2, wherein the molding material is pre-heated.

9. The manufacturing method for friction material products according to claim 3, wherein the molding material is pre-heated.

10. The manufacturing method for friction material products according to claim 4, wherein the molding material is pre-heated.

11. The manufacturing method for friction material products according to claim 5, wherein the molding material is preheated.

12. The manufacturing method for friction material products according to claim 6, wherein the molding material is pre-heated.
